(19) United States
(12) Patent Application Publication
(10) Pub. No.: US 2026/0117018 A1
(43) Pub. Date: Apr. 30, 2026

(54) AROMATIC AMINE EPOXY RESIN CURING AGENT, INSULATING EPOXY RESIN, AND PREPARATION METHOD THEREOF

(71) Applicant: XI'AN JIAOTONG UNIVERSITY, Xi'an (CN)

(72) Inventors: Boya ZHANG, Xi'an (CN); Jie LI, Xi'an (CN); Xingwen LI, Xi'an (CN); Xuanjie ZHANG, Xi'an (CN); Yixuan LI, Xi'an (CN)

(73) Assignee: XI'AN JIAOTONG UNIVERSITY, Xi'an (CN)

(21) Appl. No.: 19/326,567

(22) Filed: Sep. 11, 2025

Related U.S. Application Data
(63) Continuation of application No. PCT/CN2025/105806, filed on Jun. 30, 2025.

(30) Foreign Application Priority Data
Oct. 29, 2024 (CN) 202411522617.X

(51) Int. Cl. C08G 59/50; B29C 39/00; B29K 63/00; B29K 105/00; C08J 3/21

(52) U.S. Cl. CPC C08G 59/504; B29C 39/006; C08G 59/5033; C08J 3/212; B29K 2063/00; B29K 2105/0002; C08J 2363/02

(57) ABSTRACT

An aromatic amine epoxy resin curing agent, an insulating epoxy resin and a preparation method thereof are provided, belonging to the field of insulation technology. At least two benzene ring structures are designed; an amino functional group is respectively arranged at each end of the structure designed; no strong electron-withdrawing substituent group is arranged at the ortho position of the designed amino functional group; an aromatic amine epoxy resin curing agent is obtained. Polyaromatic diamine is used as a curing agent component of epoxy resins, and a rigid aromatic structure is introduced to enhance its thermal stability and increase the glass transition temperature; and functional bridge bonds are introduced to break the conjugated structure of benzene rings and improve electrical properties. Insulating epoxy resins help improve the electrical properties of key insulating parts in DC GIS/GIL at a high temperature gradient and high electric field conditions.

### CROSS-REFERENCE TO RELATED APPLICATIONS

The application claims priority to Chinese patent application No. 202411522617.X, filed on Oct. 29, 2024, the entire contents of which are incorporated herein by reference.

### TECHNICAL FIELD

The present disclosure belongs to the field of the insulation technology, and specifically relates to an aromatic amine epoxy resin curing agent, an insulating epoxy resin, and a preparation method thereof.

### BACKGROUND

With the large-scale development of offshore wind power and plateau hydropower, DC Gas Insulated Switchgear (GIS)/Gas Insulated Lines (GIL) have become the main equipment for large-scale clean energy transmission in the future due to their advantages such as small footprint, high reliability, and low environmental impact. Under DC voltage, the internal electric field of materials is resistively distributed, which is different from the resistive distribution of the internal electric field of the equipment under traditional DC voltage. It is easy to accumulate surface charges on the surface of insulating materials, inducing surface flashover faults. Since the operating temperature of conductor approaches the glass transition temperature of epoxy materials, while its resistivity drops sharply with rising temperature, a radial temperature gradient is induced within the insulator. This causes the peak electric field position to shift toward the grounded enclosure, reducing the effective insulation distance, aggravating the surface electric field distortion, and leading to a dramatic decline in flashover voltage.

At present, researchers mainly propose to modify materials by doping microparticles and nanoparticles to increase the electrical properties of epoxy composites. However, due to their large specific surface area, nanoparticles are prone to agglomeration and cannot disperse uniformly within materials, thereby failing to meet the requirements for large-scale industrial applications. In addition, the glass transition temperature of commercial epoxy resin matrix materials currently used for electrical insulation is only about 120° C., which further limits the electrical properties of epoxy materials for electrical use at a high temperature gradient and high electric field conditions. At present, no effective solution has been proposed for the problems in related technologies, making it difficult to meet the design requirements of key insulating parts in DC GIS/GIL.

In view of the problems of nanoparticle agglomeration, uneven dispersion, and low glass transition temperature of epoxy resin matrix materials in the modification process of epoxy composites, it is urgent to find a new type of epoxy resin for high-voltage DC insulation with high thermal stability and high electric resistivity, as well as its preparation method to meet the design requirements of key insulating parts in DC GIS/GIL under a high temperature gradient and high electric field conditions.

### SUMMARY

In order to overcome the shortcomings of the above-mentioned existing methods, the objective of the present disclosure is to provide an aromatic amine epoxy resin curing agent, an insulating epoxy resin, and a preparation method thereof to solve the technical problem of poor electrical properties of key insulating parts in DC GIS/GIL at a high temperature gradient and high electric field conditions.

To achieve the above objective, the present disclosure provides the following technical solutions:

In a first aspect, the present disclosure provides an aromatic amine epoxy resin curing agent, including:
at least two benzene ring structures, the benzene ring structures being connected by functional bridge bonds to form a design structure, an amino functional group being arranged at each end of the design structure, and no strong electron-withdrawing substituent group being arranged at the ortho position of the amino functional group; and
the functional bridge bonds being arranged at the 1,4 or 1,3 substituent positions of the benzene ring structures.

Further, the functional bridge bonds of the present disclosure are strong electron-withdrawing groups or large sterically hindered groups.

Further, the strong electron-withdrawing groups in the present disclosure are —C═O or —SO₂.

Further, the large sterically hindered groups in the present disclosure are —C₂H₆, —C₂F₆ or —C₆H₁₂.

In a second aspect, the present disclosure provides a preparation method of the insulating epoxy resin, including the following steps:
1) dissolving the preceding aromatic amine epoxy resin curing agent in a mixed solvent of acetone and dimethylacetamide, and heating and stirring them for the first time until completely dissolved to obtain an aromatic amine epoxy resin curing agent solution;
2) adding the aromatic amine epoxy resin curing agent solution obtained in step 1) to the preheated epoxy resin monomers, and heating and stirring them for the second time under continuous vacuuming conditions; adding fillers, heating and stirring them for the third time, and performing the first degassing step to obtain a casting material; and
3) pouring the casting material obtained in step 2) into a preheated mold for the second degassing step, curing, cooling it naturally to room temperature, and demolding it to obtain an insulating epoxy resin.

Further, in step 1) of the present disclosure, the dosage ratio of the aromatic amine epoxy resin curing agent to acetone to dimethylacetamide is (10-15) g:(2-8) mL:(10-15) mL; and
the heating temperature of heating and stirring for the first time is 50-80° C., and the stirring lasts for 20-40 min.

Further, in the present disclosure, the weight ratio of the aromatic amine epoxy resin curing agent to epoxy resin monomer to filler is (5-30):(10-40):(30-60);
the preheating temperature of the epoxy resin monomer is 50-80° C., and the preheating lasts for is 4-8 h;
the heating temperature of heating and stirring for the second time is 60-120° C., and the stirring lasts for 10-60 min;
the heating temperature of heating and stirring for the third time is 60-120° C., and the stirring lasts for 10-30 min; and
the conditions for the first degassing stage are: holding at 60-120° C. while maintaining pressure for 30-120 min at a vacuum of 1-10 mbar.

Further, in step 3) of the present disclosure, the method for obtaining the preheated mold includes: spraying a release agent in advance and heating it to 100° C.;
the conditions for the second degassing stage are: holding at 60-120° C. while maintaining pressure for 30-60 min at a vacuum of 1-10 mbar;
the curing conditions are: heating to 120-140° C., holding for 60-180 min; taking 60-120 min to heat it up to 150-180° C., holding for 120-300 min; and then taking 60-120 min to heat it up to 190-210° C., holding for 60-180 min.

In a third aspect, the present disclosure provides an insulating epoxy resin prepared by the preceding preparation method.

Compared with the existing art, the present disclosure has the following beneficial effects:

The present disclosure claims an aromatic amine epoxy resin curing agent, including: designing at least two benzene ring structures, introducing rigid aromatic structures to an epoxy backbone to enhance its thermal stability and increase the glass transition temperature; and enabling it to maintain its properties at higher temperatures, thereby broadening the application range of epoxy resins. The functional bridge bonds introduced between benzene rings, as a means of breaking the conjugated structure of benzene rings, are able to effectively improve the electrical properties of epoxy resins, especially the introduction of strong electron-withdrawing groups and large sterically hindered groups, which respectively block the charge transfer within and between epoxy molecular chains by constructing electron traps and hindering the π-π stacking effect between benzene rings, thereby significantly improving resistance performance. An amino functional group is arranged at each end of the structure designed. The amino functional groups serve as sites for cross-linking reaction with epoxy functional groups in epoxy resin monomers, and an amino functional group is arranged at each end to ensure that the curing agent fully reacts with the epoxy resin to form a uniform cross-linked network. Because strong electron-withdrawing groups will greatly reduce the reactivity, no strong electron-withdrawing substituent group is arranged at the ortho position of the designed amino functional group to ensure high amine reactivity during cross-linking reaction and complete curing of the material when curing large insulating parts. The functional bridge bonds are arranged at the 1,4 or 1,3 substituent positions of the benzene ring structures. Arranging at the 1,2 substituent positions may result in too low reactivity and difficulty in subsequent curing reactions. A reasonable substituent position ensures that the backbone has a certain degree of freedom and can perform axial rotation. Starting from a molecular structure design, in terms of the aromatic amine epoxy resin curing agent in the present disclosure, the inventors have systematically considered the need to improve thermal stability and electrical properties, providing scientific guidance for the development of high-performance epoxy resin curing agents. By adjusting the benzene ring structure, the type, and the substituent position of functional bridge bonds, the performance of the curing agent can be flexibly adjusted to adapt to different application requirements. It can be used to prepare epoxy resins for high-voltage DC insulation with high thermal stability and high resistivity. It helps improve the electrical properties of key insulating parts in DC GIS/GIL at a high temperature gradient and high electric field conditions.

Further, the introduced functional bridge bonds are divided into two categories. The first category includes strong electron-withdrawing groups, which construct electron traps between benzene ring structures to block charge transfer within an epoxy molecular chain. Strong electron-withdrawing groups can effectively absorb and fix electrons, thereby reducing the free movement of charges within the molecular chain. This is particularly important for electrical applications that require high resistance performance, such as key insulating parts in DC GIS/GIL, which need to maintain stable electrical properties at a high temperature gradient and high electric field conditions. The second category includes large sterically hindered groups, which use their large volume to increase the molecular spacing and hinder the π-π stacking effect between benzene rings to block the charge transfer between different epoxy molecular chains, further enhancing the resistance performance of epoxy resins and improving the overall stability and durability of the material by increasing molecular spacing. On the one hand, rigid structures are introduced to the epoxy cross-linked backbone to improve thermal stability; on the other hand, two categories of functional bridge bond groups are used to construct carrier traps and improve electrical properties.

Of the aromatic amine epoxy resin curing agent of the present disclosure the reactivity with epoxy resin monomers is considered, ensuring the smooth progress of the curing process, and thus optimizing the processing performance of epoxy resins. The agent can enhance the thermal stability of epoxy resins, significantly improve the resistance performance of epoxy resins, ensure the smooth progress of the curing process, and thus optimize the processing performance of epoxy resins.

The present disclosure further claims a preparation method of the insulating epoxy resin, which is prepared using the preceding aromatic amine epoxy resin curing agent. The aromatic amine molecules in the aromatic amine epoxy resin curing agent contain benzene ring structures, so that the cured insulating epoxy resin has excellent heat resistance and can withstand erosion in a high temperature environment without significant performance degradation. The aromatic amine epoxy resin curing agent enables the insulating epoxy resin to maintain stable performance in various chemical media, which is particularly important for insulating materials used in complex environments. The cured aromatic amine epoxy coating can form a hard surface with high strength and hardness, which makes the aromatic amine epoxy coating perform well when subjected to mechanical stress. The aromatic amine in the aromatic amine epoxy resin curing agent has high reactivity, reacts quickly with the epoxy resin, can complete the curing process in a short time, and improves production efficiency. The presence of the benzene ring structures not only improves heat resistance, but also endows the aromatic amine epoxy resin curing agent good oxidation resistance and stability, extending the service life of a product. While maintaining high strength and hardness, it also has certain flexibility and adhesion, allowing better adaptation to complex application scenarios.

The present disclosure further claims an insulating epoxy resin prepared by the preceding preparation method. By introducing rigid aromatic structures to the epoxy cross-linked backbones, the thermal stability of epoxy resins is significantly improved, so that it can maintain insulation performance for a long time in a high temperature environment. The carrier trap is constructed by using two categories of functional bridge bond groups, which effectively improves the electrical properties of epoxy resins, especially the resistance performance and breakdown strength, so that it can meet the insulation requirements of high-voltage electrical equipment. The characteristics of high thermal stability and high electrical strength make the insulating epoxy resin have a wide range of application prospects in high-voltage electrical equipment such as DC GIS/GIL.

### BRIEF DESCRIPTION OF DRAWINGS

FIG. 1 is a Fourier transform infrared spectrum of an insulating epoxy resin obtained in Embodiments 1-5 and Comparative Embodiment 1 of the present disclosure.

FIG. 2 is a differential scanning calorimetry result of an insulating epoxy resin obtained in Embodiments 1-5 and Comparative Embodiment 1 of the present disclosure.

FIG. 3 is a comparison chart of the high-temperature DC breakdown strength and high-temperature volume resistivity results of an insulating epoxy resin obtained in Embodiments 1-5 and Comparative Embodiment 1 of the present disclosure.

### DETAILED DESCRIPTION OF THE EMBODIMENTS

In order to enable those skilled in the art to better understand solutions of the present disclosure, the following will combine the accompanying drawings in the embodiments of the present disclosure to clearly and completely describe the technical solutions in the embodiments of the present disclosure. Obviously, the described embodiments are some but not all embodiments of the present disclosure. Based on the embodiments described herein, all other embodiments obtained by those of ordinary skill in the art without creative work are within the scope of protection of the present disclosure.

It should be noted that the terms “first”, “second” and the like in the description and claims of the present disclosure and the above drawings are used to distinguish similar objects, not necessarily to describe a specific order or precedence. It should be understood that the data used in this way can be interchanged under appropriate circumstances so that the embodiments of the present disclosure described herein can be implemented in an order other than those illustrated or described herein. Moreover, the terms “include” and “have” and any variations thereof are intended to cover non-exclusive inclusions. For example, a process, method, system, product or equipment that includes a series of steps or units is not necessarily limited to clearly listed steps or units, but may include other steps or units that are not clearly listed or inherent to these processes, methods, products or equipment.

The present disclosure is further described in detail below with reference to the accompanying drawings:

The present disclosure claims an aromatic amine epoxy resin curing agent, which may include the following:
1) The curing agent contains two or more benzene ring structures, and the benzene structures are connected by functional bridge bonds to form a structure designed.
2) The preceding structure designed contains an amino functional group at each end as a site for cross-linking reaction with the epoxy functional group in the epoxy resin monomers, ensuring that the high thermal stability benzene ring structure can serve as the main body of the epoxy cross-linked structure, thereby improving the thermal stability of the material.
3) No strong electron-withdrawing substituent group is arranged at the ortho position of the preceding amino functional group to ensure high amine reactivity during the cross-linking reaction and complete curing of the material when curing large insulating parts.
4) The benzene rings of the curing agent are connected by functional bridge bonds, and the functional bridge bonds are located at the 1,4 or 1,3 substituent positions of the benzene rings to ensure that the backbone has a certain degree of freedom and can perform axial rotation.

It should be noted that functional bridge bonds can be divided into two categories. The first category of functional bridge bonds is strong electron-withdrawing groups, which block the transmission of π electrons between benzene rings within the chain; the second category of functional bridge bonds is large sterically hindered groups, which increase the molecular spacing and block the electron transmission between different chains. Strong electron-withdrawing groups and large sterically hindered groups are arranged at the para position of amino groups.

It should be noted that strong electron-withdrawing groups, also known as electron-regulating groups, refer to bridged groups that can regulate the electronic properties of molecules by changing the electron density on the benzene ring. Such groups affect the charge transfer capacity of molecules, and their mechanism of action includes the combined effect of electronegativity, inductive effect, and resonance effect. For example, groups such as —O—, —S—, carbonyl (—C═O) and sulfonyl (—SO₂) can reduce the electron density of adjacent benzene rings through inductive or resonance effects, thereby inhibiting non-local electron transmission and improving the insulation performance of materials. In semi-quantitative analysis, the influence of these groups on the electronic structure and performance of molecules can be evaluated by theoretical calculation methods such as Mulliken charge distribution and electrostatic potential distribution combined with experimentally measured electrical properties. The introduction of strong electron-withdrawing groups usually leads to a significant decrease in the electron density in the benzene ring region, which helps improve the insulation performance of epoxy resins.

It should be noted that large sterically hindered groups refer to bridge groups with large volumes that can significantly affect intermolecular stacking and molecular chain conformation. Such groups mainly change the stacking mode and free volume of molecules through steric hindrance effect, thus affecting the insulation performance of materials. For example, the introduction of large-volume groups such as —C₂H₆, —C₂F₆, and —C₆H₁₀ will destroy the tight packing of molecular chains and increase the free volume ratio and molecular spacing. Through molecular dynamics simulation and X-ray diffraction experiments, it can be seen that after the introduction of large sterically hindered groups, the free volume ratio, and molecular chain spacing of epoxy resins are significantly increased, which helps improve the insulation performance of materials. Compared with electron-regulating groups, large sterically hindered groups have a more significant effect on molecular spacing, but they may have overlapping functions in some cases (for example, 6FDAM has both electron-withdrawing and steric hindrance effects).

The distinction between strong electron-withdrawing groups and large sterically hindered groups is mainly based on their electronic effect and steric effect, but in an actual molecular design, some bridge groups may have both functions at the same time. For strong electron-withdrawing groups, semi-quantitative analysis can be performed by theoretical calculations (such as Mulliken charge distribution and electrostatic potential distribution) and experimental data; for large sterically hindered groups, they are mainly characterized by molecular structure parameters (such as free volume and molecular spacing).

Among them, the first category of functional bridge bonds is strong electron-withdrawing groups, including but not limited to —C═O or —SO₂, such as one or two of Formula 1 to Formula 2:

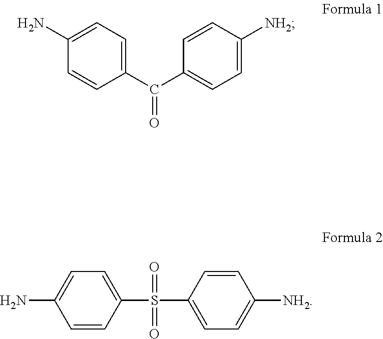 [SMILES: Nc1ccc(C(=O)c2ccc(N)cc2)cc1 ; Nc1ccc(S(=O)(=O)c2ccc(N)cc2)cc1]

The second category of functional bridge bonds is large sterically hindered groups, including but not limited to —C₂H₆, —C₂F₆ or —C₆H₁₂, such as one or more of Formula 3 to Formula 5:

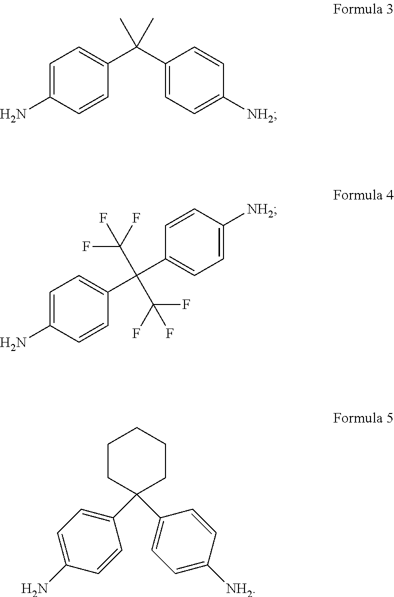 [SMILES: CC(C)(c1ccc(N)cc1)c1ccc(N)cc1 ; Nc1ccc(C(c2ccc(N)cc2)(C(F)(F)F)C(F)(F)F)cc1 ; Nc1ccc(C2(c3ccc(N)cc3)CCCCC2)cc1]

The present disclosure claims an aromatic amine epoxy resin curing agent, including: designing at least two benzene ring structures, and introducing rigid aromatic structures to an epoxy backbone to enhance its thermal stability and increase the glass transition temperature. Benzene ring structures can provide sufficient rigidity and stability, so that the cured epoxy resin has better mechanical properties and thermal stability. Multiple benzene ring structures can enhance the intermolecular force of a curing agent and increase the cross-linking density of an epoxy resin, thereby improving its hardness, strength and heat resistance. The benzene ring structures are connected by functional bridge bonds; by introducing functional bridge bonds between the benzene rings as a means to break the conjugated structure of the benzene ring and improve the electrical properties, the selection and design of functional bridge bonds are crucial to the performance of the curing agent. It connects different benzene ring structures, affecting the flexibility and reactivity of the curing agent and the performance of the resulted epoxy resin. By selecting the appropriate functional bridge bonds, the chemical properties of the curing agent, such as reaction rate and curing temperature, can be adjusted to optimize the processing performance and final use performance of the epoxy resin. An amino functional group is arranged at each end of the structure designed. The amino functional groups serve as sites for cross-linking reaction with epoxy functional groups in epoxy resin monomers, and an amino functional group is arranged at each end to ensure that the curing agent fully reacts with the epoxy resin to form a uniform cross-linked network. It makes the curing agent have high reactivity and the agent can react quickly and completely with the epoxy resin to form a dense cross-linked structure, thereby improving the mechanical properties and chemical corrosion resistance of the epoxy resin. No strong electron-withdrawing substituent group is arranged at the ortho position of the designed amino functional group; the presence of a strong electron-withdrawing substituent group will reduce the reactivity of the amino functional group, thereby affecting the reaction efficiency between the curing agent and the epoxy resin. Therefore, it is avoided to arrange such substituent groups at the ortho position of the amino functional group during design. The design ensures that the amino functional group maintains a high reactivity, so that the curing agent can react fully and quickly with the epoxy resin to form a high-quality cross-linked network, thereby improving the comprehensive performance of the epoxy resin. Reasonable substituent positions can optimize the molecular configuration of curing agents and improve their reactivity and stability. It further regulates the chemical and physical properties of the curing agent, such as solubility, viscosity, so that it can better adapt to different epoxy resin systems and processing conditions. It is used to prepare epoxy resins for high-voltage DC insulation with high thermal stability and high electrical resistivity. It helps improve the electrical properties of key insulating parts in DC GIS/GIL at a high temperature gradient and high electric field conditions.

During the design of the aromatic amine epoxy resin curing agent of the present disclosure, the reactivity with epoxy resin monomers is considered. It ensures the smooth progress of the curing process, and thus optimizes the processing performance of the epoxy resin. The agent can enhance the thermal stability of epoxy resins, significantly improve the resistance performance of epoxy resins, ensure the smooth progress of the curing process, and thus optimize the processing performance of epoxy resins.

The present disclosure further claims a preparation method of the insulating epoxy resin, including the following steps:
1) dissolution of the aromatic amine epoxy resin curing agent: dissolving the preceding aromatic amine epoxy resin curing agent in a mixed solvent of acetone and dimethylacetamide, and heating and stirring them for the first time until the aromatic amine epoxy resin curing agent is completely dissolved in the solvent to obtain an aromatic amine epoxy resin curing agent solution;
2) dispersion of the aromatic amine epoxy resin curing agent: adding the preceding aromatic amine epoxy resin curing agent solution to the preheated epoxy resin monomers, and heating and stirring them for the second time under continuous vacuuming conditions;
3) casting: adding fillers (generally Al₂O₃ particles) to the preceding mixture, heating and stirring them for the third time, and performing the first degassing step to obtain a casting material; and
4) curing: pouring the casting material obtained in step 3) into a preheated mold for the second degassing step, raising the curing environment temperature to 120-140° C. and holding for 60-180 min; taking 60-120 min to heat it up to 150-180° C. and holding for 120-300 min; taking 60-120 min to heat it up to 190-210° C. and holding for 60-180 min; and then, stopping heating, cooling it naturally to room temperature with the oven, and demolding to obtain an insulating epoxy resin.

In some embodiments of the present disclosure, in step 1), the dosage ratio of aromatic amine epoxy resin curing agent to acetone to dimethylacetamide is (10-15) g:(2-8) mL:(10-15) mL. Such a ratio setting can ensure that the aromatic amine epoxy resin curing agent is completely dissolved in the solvent, and ensure subsequent uniform dispersion of the aromatic amine epoxy resin curing agent in the epoxy resin, which is conducive to improving the comprehensive performance of the cured epoxy resin.

In some embodiments of the present disclosure, the heating temperature for heating and stirring for the first time is 50-80° C., and the heating and stirring lasts for 20-40 min.

In some embodiments of the present disclosure, in step 2), the preheating temperature of the epoxy resin is 50-80° C. for 4-8 h to improve the fluidity of the epoxy resin and remove moisture.

In some embodiments of the present disclosure, the temperature of the heating and stirring for the second time and the heating and stirring for the third time is 60-120° C., and the stirring lasts for 10-60 min, depending on the reactivity of the curing agent and the solvent content, so that all the solvents are volatilized, and the vacuum is 1-10 mbar.

It should be noted that the heating temperature of the heating and stirring for the first time is slightly lower than the heating temperature of the heating and stirring for the second time and the heating and stirring for the third time, which can prevent processing difficulties caused by increased viscosity of the mixture, and can quickly cure during subsequent curing to prevent filler settlement.

In some embodiments of the present disclosure, in step 3), the first degassing step refers to keeping the epoxy resin mixture and filler at a vacuum of 1-10 mbar and a temperature of 60-120° C. for 30-120 min to ensure that the viscosity of the casting material is 6,000-12,000 mPa·s.

In some embodiments of the present disclosure, the weight ratio of the aromatic amine epoxy resin curing agent to epoxy resin monomer to filler is (5-30):(10-40):(30-60); the heating temperature for heating and stirring is 60-120° C., and the stirring lasts for 10-30 min. The ratio of epoxy resin to aromatic amine epoxy resin curing agent here can ensure that the epoxy resin and the aromatic amine epoxy resin curing agent react completely, which is conducive to improving the comprehensive performance of the cured epoxy resin. And a high proportion of fillers can enhance the mechanical strength of the cured epoxy resin.

In some embodiments of the present disclosure, in step 4), the mold needs to be sprayed with a release agent in advance and then heated to 100° C.

The conditions for degassing are: holding at 60-120° C. while maintaining pressure for 30-60 min at a vacuum of 1-10 mbar.

The present disclosure claims a preparation method of an insulating epoxy resin, which is prepared using the preceding aromatic amine epoxy resin curing agent. The use of a mixed solvent helps the aromatic amine epoxy resin curing agent to dissolve better. Heating and stirring ensure that the curing agent is completely dissolved in the solvent, providing a uniform and stable curing agent solution for subsequent steps, which is conducive to improving the quality and performance of the final product. Preheating the epoxy resin monomers helps reduce its viscosity, facilitating mixing with the curing agent solution. Continuous vacuuming and mixing under heating and stirring conditions will help remove bubbles and volatile substances in the mixture, improving the uniformity and density of the casting material. Adding fillers and heating and stirring again can further improve the performance of the casting material, such as mechanical strength and heat resistance. The first degassing step helps further remove gases from the casting material, reducing pores and defects in the final product. Preheating the mold helps the casting material fill the mold better, reducing stress caused by temperature differences. The second degassing step further ensures that the gas in the casting material is removed, improving the density and insulation performance of the product. The curing process allows the casting material to form a stable chemical structure, giving the final product the required mechanical strength and electrical properties. Demolding after natural cooling to room temperature helps reduce product deformation or cracking caused by rapid temperature changes.

The present disclosure further claims an insulating epoxy resin prepared by the preceding preparation method. By introducing rigid aromatic structures to the epoxy cross-linked backbones, the thermal stability of epoxy resins is significantly improved, so that it can maintain insulation performance for a long time in a high temperature environment. The carrier trap is constructed by using two categories of functional bridge bond groups, which effectively improves the electrical properties of epoxy resins, especially the resistance performance and breakdown strength, so that it can meet the insulation requirements of high-voltage electrical equipment. The characteristics of high thermal stability and high electrical strength make this insulating epoxy resin have a wide range of application prospects in high-voltage electrical equipment such as DC GIS/GIL.

The present disclosure is further described as follows through multiple embodiments and comparative embodiments. In the following embodiments and comparative embodiments, the raw materials used are as follows:
Diglycidyl ether bisphenol A (DGEBA, WSR618 E51, epoxy value: 0.51 eq./100 g), provided by Nantong Xingchen Synthetic Materials Co., Ltd., China.

4,4′-diaminodiphenylmethane (DDM), 4,4′-diaminobenzophenone (DBP) and 2,2-bis(4-aminophenyl) hexafluoropropane (6FDAM), provided by Shanghai Macklin Biochemical Co., Ltd., China.

Methyltetrahydrophthalic anhydride (MTHPA), 2,4,6-trimethylphenol, acetone, and N,N-dimethylacetamide (DMAc), provided by Sigma-Aldrich, USA.

### Embodiment 1

A preparation method of an insulating epoxy resin, including the following steps:

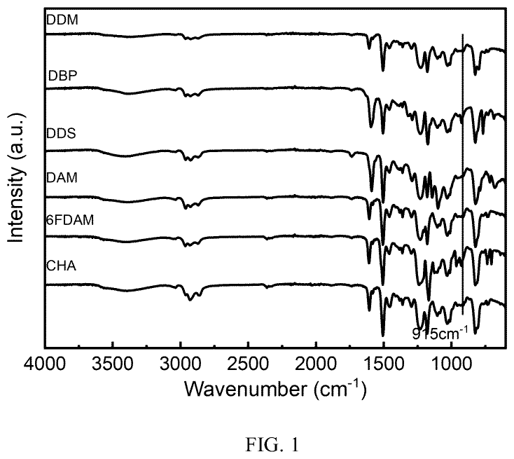

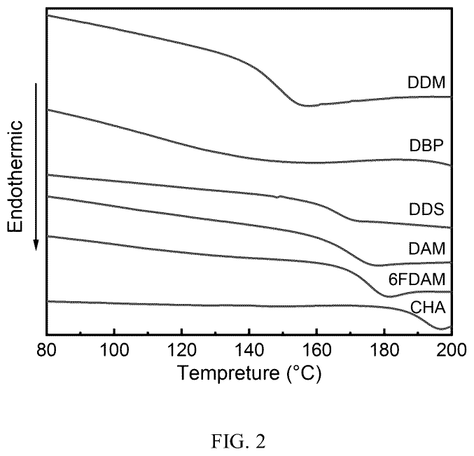

In Embodiment 1, 4,4′-diaminobenzophenone (DBP) containing two benzene ring structures and a strong electron-withdrawing group —C═O is used as an aromatic amine epoxy resin curing agent, and the functional bridge bond is at the 1,4 substituent position on the benzene ring (see Formula 3). The preparation method of the insulating epoxy resin provided includes the following steps:
1) dissolving 10 g of DBP in 2 mL of acetone and 10 mL of dimethylacetamide, heating to 50° C., heating and stirring for 20 min to completely dissolve DBP to obtain an aromatic amine epoxy resin curing agent solution;
2) preheating the epoxy resin in an oven at 60° C. for 5 h in advance, then mixing the preceding aromatic amine epoxy resin curing agent solution with 10 g of epoxy resin, heating and stirring them in a continuously vacuumed beaker with the temperature at 70° C. and the stirring lasting for 30 min; then, adding 30 g of alumina filler to the mixture, heating and stirring them at 60° C. for 30 min, and degassing at a vacuum of 1 mbar and 60° C. for 30 min to obtain a casting material;
3) heating the above-obtained casting material to 120° C., preheating the mold to 100° C. after spraying a release agent, pouring the casting material into the mold, and degassing at 100° C. at a vacuum of 10 mbar for 60 min; and
4) then heating the ambient temperature to 140° C. within 60 min and holding for 60 min; heating to 180° C. within 60 min and holding for 120 min; heating to 200° C. within 60 min and holding for 60 min; and then stopping heating, naturally cooling it to room temperature with the oven, and demolding to obtain an insulating epoxy resin, named EP-DBP (recorded as DBP in FIG. 1 and FIG. 2).

### Embodiment 2

A preparation method of an insulating epoxy resin, including the following steps:

In Embodiment 2, 4,4′-diaminodiphenyl sulfone (DDS) containing two benzene ring structures and a strong electron-withdrawing group —SO₂ is used as an aromatic amine epoxy resin curing agent (see Formula 2). The preparation method of the insulating epoxy resin provided includes the following steps:
1) dissolving 30 g DDS in 5 mL acetone and 12 mL dimethylacetamide, heating to 60° C., heating and stirring for 30 min to completely dissolve the DDS to obtain an aromatic amine epoxy resin curing agent solution;
2) preheating the epoxy resin in an oven at 80° C. for 4 h in advance, then mixing the preceding aromatic amine epoxy resin curing agent solution with 20 g of epoxy resin, heating and stirring them in a continuously vacuumed beaker with the temperature at 60° C. and the stirring lasting for 30 min; then, adding 30 g of alumina filler to the mixture, heating and stirring them at 60° C. for 30 min, and degassing at a vacuum of 5 mbar and 80° C. for 60 min to obtain a casting material;
3) heating the above-obtained casting material to 130° C., preheating the mold to 100° C. after spraying a release agent, pouring the casting material into the mold, and degassing at 100° C. at a vacuum of 5 mbar for 60 min; and
4) then heating the ambient temperature to 120° C. within 60 min and holding for 180 min; heating to 150° C. within 120 min and holding for 180 min; heating to 190° C. within 60 min and holding for 180 min; and then stopping heating, naturally cooling it to room temperature with the oven, and demolding to obtain an insulating epoxy resin, named EP-DDS (recorded as DDS in FIG. 1 and FIG. 2).

### Embodiment 3

A preparation method of an insulating epoxy resin, including the following steps:

In Embodiment 3, 2,2-bis(4-aminophenyl) propane (DAM) containing two benzene ring structures and a large sterically hindered group —C₂H₆ is used as an aromatic amine epoxy resin curing agent (see Formula 3). The preparation method of the insulating epoxy resin provided includes the following steps:
1) dissolving 12 g of DAM in 6 mL of acetone and 14 mL of dimethylacetamide, heating to 60° C., heating and stirring for 25 min to completely dissolve DAM to obtain an aromatic amine epoxy resin curing agent solution;
2) preheating the epoxy resin in an oven at 50° C. for 8 h in advance, then mixing the preceding aromatic amine epoxy resin curing agent solution with 35 g of epoxy resin, heating and stirring them in a continuously vacuumed beaker with the temperature at 80° C. and the stirring lasting for 20 min; then, adding 45 g of alumina filler to the mixture, heating and stirring them at 60° C. for 10 min, and degassing at a vacuum of 3 mbar and 90° C. for 45 min to obtain a casting material;
3) heating the above-obtained casting material to 115° C., preheating the mold to 100° C. after spraying a release agent, pouring the casting material into the mold, and degassing at 90° C. at a vacuum of 5 mbar for 60 min; and
4) then heating the ambient temperature to 130° C. within 60 min and holding for 90 min; heating to 150° C. within 100 min and holding for 120 min; heating to 210° C. within 120 min and holding for 120 min; and then stopping heating, naturally cooling it to room temperature with the oven, and demolding to obtain an insulating epoxy resin, named EP-DAM (recorded as DAM in FIG. 1 and FIG. 2).

### Embodiment 4

A preparation method of an insulating epoxy resin, including the following steps:

In Embodiment 4, 2,2-bis(4-aminophenyl) hexafluoropropane (6FDAM) containing two benzene ring structures and a large volume bridge bond-C₂F₆ is used as an aromatic amine epoxy resin curing agent, and the functional bridge bond is at the 1,4 substituent position on the benzene ring (see Formula 4). The preparation method of the insulating epoxy resin provided includes the following steps:
1) dissolving 15 g of 6FDAM in 8 mL of acetone and 15 mL of dimethylacetamide, heating to 80° C., heating and stirring for 40 min to completely dissolve 6FDAM to obtain an aromatic amine epoxy resin curing agent solution;
2) preheating the epoxy resin in an oven at 50° C. for 5 h in advance, then mixing the preceding aromatic amine epoxy resin curing agent solution with 40 g of epoxy resin, heating and stirring them in a continuously vacuumed beaker with the temperature at 120° C. and the stirring lasting for 60 min; then, adding 60 g of alumina filler to the mixture, heating and stirring them at 120° C. for 30 min, and degassing at a vacuum of 10 mbar and 120° C. for 120 min to obtain a casting material;
3) heating the above-obtained casting material to 140° C., preheating the mold to 100° C. after spraying a release agent, pouring the casting material into the mold, and degassing at 100° C. at a vacuum of 1 mbar for 60 min; and
4) then heating the ambient temperature to 140° C. within 60 min and holding for 60 min; heating to 180° C. within 60 min and holding for 120 min; heating to 200° C. within 60 min and holding for 60 min; and then stopping heating, naturally cooling it to room temperature with the oven, and demolding to obtain an insulating epoxy resin, named EP-6FDAM (recorded as 6FDAM in FIG. 1 and FIG. 2).

### Embodiment 5

A preparation method of an insulating epoxy resin, including the following steps:

In Embodiment 5, 1,1-bis(4-aminophenyl)cyclohexane (CHA) containing two benzene ring structures and a large sterically hindered group —C₆H₁₂ is used as an aromatic amine epoxy resin curing agent (see Formula 5), and the preparation method of the insulating epoxy resin provided includes the following steps:
1) dissolving 10 g of CHA in 7 mL of acetone and 13 mL of dimethylacetamide, heating to 75° C., heating and stirring for 25 min to completely dissolve CHA to obtain an aromatic amine epoxy resin curing agent solution;
2) preheating the epoxy resin in an oven at 67° C. for 5 h in advance, then mixing the preceding aromatic amine epoxy resin curing agent solution with 28 g of epoxy resin, heating and stirring them in a continuously vacuumed beaker with the temperature at 110° C. and the stirring lasting for 40 min; then, adding 50 g of alumina filler to the mixture, heating and stirring them at 110° C. for 30 min, and degassing at a vacuum of 8 mbar and 90° C. for 70 min to obtain a casting material;
3) heating the above-obtained casting material to 110° C., preheating the mold to 100° C. after spraying a release agent, pouring the casting material into the mold, and degassing at 110° C. at a vacuum of 1 mbar for 60 min; and
4) then heating the ambient temperature to 140° C. within 60 min and holding for 120 min; heating to 180° C. within 120 min and holding for 300 min; heating to 210° C. within 120 min and holding for 180 min; and then stopping heating, naturally cooling it to room temperature with the oven, and demolding to obtain an insulating epoxy resin, named EP-CHA (recorded as CHA in FIG. 1 and FIG. 2).

### Comparative Embodiment 1

A preparation method of an insulating epoxy resin, including the following steps:

In Comparative Embodiment 1, 4,4′-diaminodiphenylmethane (DDM) containing two benzene ring structures is used as a curing agent, and the two benzene rings are directly connected by methylene. The preparation method of epoxy resin samples provided includes the following steps:
1) dissolving 10 g of DDM in 2 mL of acetone and 10 mL of dimethylacetamide, heating to 60° C., heating and stirring for 20 min to completely dissolve DDM;
2) preheating the epoxy resin in an oven at 60° C. for 5 h in advance, then mixing the preceding aromatic amine epoxy resin curing agent solution with 15 g of epoxy resin, heating and stirring them in a continuously vacuumed beaker at 70° C. for 30 min; then adding 40 g of alumina filler to the mixture, heating and stirring them at 60° C. for 30 min to obtain a casting material;
3) heating the above-obtained casting material to 100° C., preheating the mold to 100° C. after spraying a release agent, pouring the casting material into the mold, and degassing at 100° C. at a vacuum of 10 mbar for 60 min; and
4) then heating the ambient temperature to 140° C. within 60 min and holding for 60 min; heating to 180° C. within 60 min and holding for 120 min; heating to 200° C. within 60 min and holding for 60 min; and then stopping heating, naturally cooling it to room temperature with the oven, and demolding to obtain an insulating epoxy resin, named EP-DDM (recorded as DDM in FIG. 1 and FIG. 2).

The curing agent used in Comparative Embodiment 1 here is a traditionally commonly used aniline curing agent. The 1,4 substituent positions between the two benzene rings are directly connected through methylene, so a charge transfer channel will be formed between the benzene ring structures within and between the molecular chains, resulting in weak electrical insulation performance. Therefore, as a comparison, the effect of the introduction of functional bridge bonds on the electrical and thermal properties of aniline-cured epoxy resin is verified.

See FIG. 1 for the Fourier transform infrared spectrum of the insulating epoxy resin obtained in Embodiments 1-5 and Comparative Embodiment 1 of the present disclosure; Fourier transform infrared tests are performed on the insulating epoxy resins prepared in Embodiments 1-5 and Comparative Embodiment 1, and the test results are compared and analyzed. The analysis results are shown in FIG. 1. It can be seen that the methods provided in Embodiments 1-5 and Comparative Embodiment 1 all ensure that the cross-linking reaction between the epoxy resin and the curing agent is complete.

See FIG. 2 for the differential scanning calorimetry result of the insulating epoxy resin obtained in Embodiments 1-5 and Comparative Embodiment 1 of the present disclosure; to analyze and compare the influence of the proposed method on thermal stability, differential scanning calorimetry was used to measure the insulating epoxy resins prepared in Embodiments 1-5 and Comparative Embodiment 1 at a rate of 10° C./min under nitrogen atmosphere, and the test results are compared and analyzed. The analysis results are shown in FIG. 2. It can be seen that the introduction of benzene rings leads to an increase in the glass transition temperature of epoxy resin, which is much higher than the glass transition temperature of traditional anhydride-cured epoxy resin (about 120° C.). It can be seen that the thermal stability of epoxy resin has been improved due to the introduction of polyphenyl ring curing agent.

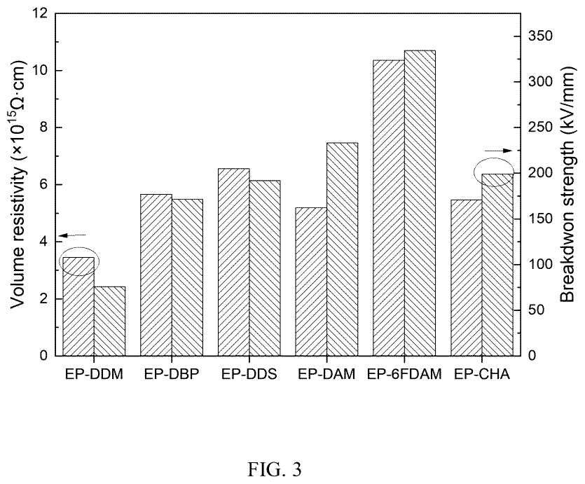

See FIG. 3 for a comparison of the high-temperature DC breakdown strength and high-temperature volume resistivity results of the insulating epoxy resin obtained in Embodiments 1-5 and Comparative Embodiment 1 of the present disclosure; to verify the influence of the proposed method on the high-temperature electrical properties of epoxy resins, high-temperature electrical property tests are performed on the insulating epoxy resins obtained in Embodiments 1-5 and Comparative Embodiment 1. The DC breakdown strength test results and DC volume resistivity test results at 120° C. are shown in FIG. 3. It can be seen that the aromatic amine epoxy resin curing agents containing strong electron-withdrawing bridge bonds and large volume bridge bonds can maintain high electrical properties at high temperatures. For EP-6FDAM, its breakdown strength at 120° C. reached 393.83 kV/mm and volume resistivity reached 2.91×10¹⁴ Ω·cm, both of which are much higher than the properties of traditional anhydride-cured epoxy resins.

The present disclosure proposes a strategy for developing an electrical epoxy resin formulation with high thermal stability and high resistance performance by using polyaromatic structures and functional bridge bonds. The core is to use polyaromatic diamines as the curing agent component of epoxy resins, introduce rigid aromatic structures to an epoxy backbone to enhance its thermal stability and increase the glass transition temperature; and moreover, to introduce functional bridge bonds between benzene rings as a means to break the conjugated structure of benzene rings and improve electrical properties. The introduced functional bridge bonds are divided into two categories. The first category is strong electron-withdrawing groups, which construct electron traps between the benzene ring structures to block the charge transfer within the epoxy molecular chain. The second category is large sterically hindered groups, which use their large volume to hinder the π-π stacking effect between the benzene rings to block the charge transfer between different epoxy molecular chains. By designing the molecular structure of polyaniline functional bridge amine curing agent, rigid structures are introduced to the epoxy cross-linked backbone to improve thermal stability; on the other hand, two categories of functional bridge bond groups are used to construct carrier traps and improve electrical properties. The formed epoxy resin material with high thermal stability and high electrical strength helps solve the electrical properties of key insulating parts in DC GIS/GIL at a high temperature gradient and high electric field conditions.

The above content is only to illustrate the technical idea of the present disclosure, and cannot limit the scope of protection of the present disclosure. Any changes made on the basis of the technical solution in accordance with the technical idea proposed by the present disclosure shall fall within the scope of protection of the claims of the present disclosure.

What is claimed is:

1. An aromatic amine epoxy resin curing agent, comprising:
at least two benzene ring structures, the benzene ring structures being connected by functional bridge bonds to form a design structure, an amino functional group being arranged at each end of the design structure, and no strong electron-withdrawing substituent group being arranged at the ortho position of the amino functional group; and
the functional bridge bonds being arranged at the 1,4 or 1,3 substituent positions of the benzene ring structures.

2. The aromatic amine epoxy resin curing agent according to claim 1, wherein the functional bridge bonds are strong electron-withdrawing groups or large sterically hindered groups.

3. The aromatic amine epoxy resin curing agent according to claim 2, wherein the strong electron-withdrawing groups are —C═O or —SO₂.

4. The aromatic amine epoxy resin curing agent according to claim 2, wherein the large sterically hindered groups are —C₂H₆, —C₂F₆ or —C₆H₁₂.

5. A preparation method of an insulating epoxy resin, comprising the following steps:
1) dissolving the preceding aromatic amine epoxy resin curing agent according to claim 1 in a mixed solvent of acetone and dimethylacetamide, and heating and stirring them for the first time until completely dissolved to obtain an aromatic amine epoxy resin curing agent solution;
2) adding the aromatic amine epoxy resin curing agent solution obtained in step 1) to the preheated epoxy resin monomers, and heating and stirring them for the second time under continuous vacuuming conditions; adding fillers, heating and stirring them for the third time, and performing the first degassing step to obtain a casting material; and
3) pouring the casting material obtained in step 2) into a preheated mold for the second degassing step, curing, cooling it naturally to room temperature, and demolding it to obtain an insulating epoxy resin.

6. The preparation method of an insulating epoxy resin according to claim 5, wherein in step 1), the dosage ratio of the aromatic amine epoxy resin curing agent to acetone to dimethylacetamide is (10-15) g:(2-8) mL:(10-15) mL; and
the heating temperature of heating and stirring for the first time is 50-80° C., and the stirring lasts for 20-40 min.

7. The preparation method of an insulating epoxy resin according to claim 5, wherein the weight ratio of the aromatic amine epoxy resin curing agent to epoxy resin monomer to filler is (5-30):(10-40):(30-60);
the preheating temperature of the epoxy resin monomer is 50-80° C., and the preheating lasts for is 4-8 h;
the heating temperature of heating and stirring for the second time is 60-120° C., and the stirring lasts for 10-60 min;
the heating temperature of heating and stirring for the third time is 60-120° C., and the stirring lasts for 10-30 min; and
the conditions for the first degassing stage are: holding at 60-120° C. while maintaining pressure for 30-120 min at a vacuum of 1-10 mbar.

8. The preparation method of an insulating epoxy resin according to claim 5, wherein in step 3), the method for obtaining the preheated mold comprises spraying a release agent in advance and heating it to 100° C.;
the conditions for the second degassing stage are: holding at 60-120° C. while maintaining pressure for 30-60 min at a vacuum of 1-10 mbar; and
the curing conditions are: heating to 120-140° C., holding for 60-180 min; taking 60-120 min to heat it up to 150-180° C., holding for 120-300 min; and then taking 60-120 min to heat it up to 190-210° C., holding for 60-180 min.

9. An insulating epoxy resin, wherein it is prepared by the preparation method according to claim 5.
